(19) United States
(12) Patent Application Publication
(10) Pub. No.: US 2020/0122861 A1
(43) Pub. Date: Apr. 23, 2020

(54) TAPE-SPRING DEPLOYABLE DEVICE

(71) Applicant: THALES, COURBEVOIE (FR)

(72) Inventors: Yannick BAUDASSÉ, CANNES LA BOCCA (FR); Xavier FRANCOIS, CANNES LA BOCCA (FR); François GUINOT, CANNES LA BOCCA (FR); Valentin BOUCHET, CANNES LA BOCCA (FR)

(21) Appl. No.: 16/601,407

(22) Filed: Oct. 14, 2019

(30) Foreign Application Priority Data
Oct. 18, 2018 (FR) 1801095

(51) Int. Cl. B64G 1/22; H01Q 1/08

(52) U.S. Cl. CPC B64G 1/222; B65H 75/364; B65H 2701/371; H01Q 1/087

(57) ABSTRACT

A deployable device includes a plurality of stowing rollers that can each move in rotation about a first axis Zi, a plurality of tape-springs, each capable of passing from a wound configuration in one of the stowing rollers to a deployed configuration along a second axis Xi substantially perpendicular to the first axis Zi of the associated stowing roller and having a substantially concave face, the concave faces of the tape-springs facing one another, the tape-springs being at least partially superposed in pairs over a contact surface. The deployable device comprises a reversible adherent link on the contact surface between at least two of the tape-springs in the deployed configuration.

### CROSS-REFERENCE TO RELATED APPLICATIONS

This application claims priority to foreign French patent application No. FR 1801095, filed on Oct. 18, 2018, the disclosure of which is incorporated by reference in its entirety.

### FIELD OF THE INVENTION

The present invention relates to a tape-spring deployable device. It applies notably to the field of space equipment to be deployed in orbit and, more particularly, to space equipment for satellites, such as antennas, solar generators or instruments. However, the invention applies to any other field in which it is desirable to distance an object from a carrying structure.

In the space field, tape-springs are frequently used in deployment. In the stored (or wound) position, tape-springs are wound about a mandrel. Tape-springs deploy autonomously by their spontaneous unwinding when the mandrel is free to rotate. Tape-springs are known in the space field as being flexible strips that have a circular-arc cross section, the radius of curvature of which is convex on a first face and concave on a second face, these strips being capable of passing from the wound state to the unwound state essentially by virtue of their intrinsic elastic energy. There are various types of strip that have intrinsic properties. Monostable strips have a natural deployed position and require holding in a stored position. Monostable tape-springs thus have a natural tendency to deploy themselves such as to lie in their unwound state. Deployment of monostable strips is often chaotic and uncontrolled. Bistable strips have two natural positions (wound position and deployed position) and do not require holding in the wound position when the cross section is totally flattened. Their deployment is linear and controlled.

### BACKGROUND

When it is desired to distance the object from the carrying structure, for example in order to position an object, the tape-springs have to ensure holding of the object in the wound configuration and the rigidity of the assembly during deployment. In point of fact, tape-springs do not have the same stiffness along the stress axis. A force F applied to the convex face of the tape-spring will have a tendency to cause the tape-spring to flex, whereas the same force applied to the concave face will have no effect, which poses a problem of instability of the flexible structure in its deployed state. To solve this problem of stability in the deployed state, it is known to use two tape-springs, as shown in FIG. 1. This is a “bi-STEM” device 1 (STEM being the abbreviation for “Storable Tubular Extendible Member”) in which two tape-springs 2, 3 are wound in an opposing manner in the wound configuration and fit into one another in the deployed configuration in order to achieve enhanced stiffness as compared with the use of a single tape-spring. However, this system requires clips 4 for fastening the tape-springs 2, 3 together. These clips are integrated into the tape-springs and render them fragile. This results in there being a risk of generating incipient ruptures, which is prejudicial to the satisfactory functioning of the deployment device. Alternatively, this system may comprise anchoring points machined into one of the two tape-springs, and the second tape-spring comprises portions that are positioned in these anchoring points. Here, once again, the machining of the tape-springs generates forces that may create fissures on the tape-springs. Moreover, these two alternatives require a complex design for the tape-springs. Lastly, these embodiments involve the existence of a clearance between the two tape-springs, prejudicial in terms of the positioning of the object.

Document EP 2 354 006 describes a tape-spring deployable device with surface attachments 30 between two tape-springs. The contact surface thus defined between two tape-springs is positioned between two concave face portions of the tape-springs. Torsional stressing of the mast thus formed by linking the two tape-springs gives rise to loads, combined with a risk of detachment of the adherent elements owing to the radial positioning and the amplitude of the movement (stressing outside of the plane). The same arises in the case of flexural stressing of the mast. This solution offers lower performance for equivalent mass.

### SUMMARY OF THE INVENTION

The invention aims to palliate all or some of the problems cited above by proposing a deployable device that offers the advantage of being compact and simple to produce, optimizing the volume and the mass of the assembly, permitting holding of the object to be distanced from the carrying structure in the wound configuration and ensuring the rigidity of the assembly during the deployment phase and in the deployed configuration.

To that end, a subject of the invention is a deployable device comprising:
a plurality of stowing rollers that can each move in rotation about a first axis Zi,
a plurality of tape-springs, each being capable of passing from a wound configuration in one of the stowing rollers to a deployed configuration along a second axis Xi substantially perpendicular to the first axis Zi of the associated stowing roller and having a substantially concave face, the concave faces of the tape-springs facing one another, the tape-springs being at least partially superposed in pairs over a contact surface, and a reversible adherent link on the contact surface between at least two of the tape-springs in the deployed configuration.

According to one embodiment, the reversible adherent link comprises protuberances on one tape-spring and thread loops on another tape-spring.

According to another embodiment the reversible adherent link comprises a plurality of hairs that adhere by means of Van der Waals forces, preferably setae, and more preferably setae comprising spatular tips at their end.

The reversible adherent link on the contact surface may be punctiform or linear.

Advantageously, each of the plurality of tape-springs having a free end, the free ends of the plurality of tape-springs are linked rigidly together in the deployed configuration.

Advantageously, at least one tape-spring of the plurality of tape-springs has a non-constant thickness along an axis Yi substantially perpendicular to the axis Xi and to the axis Zi, preferably of decreasing thickness towards the free end, and/or a non-constant width along the first axis Zi, preferably of decreasing width towards the free end.

Advantageously, the deployable device comprises a rotation drive motor configured such as to drive the plurality of stowing rollers.

According to another embodiment, the deployable device comprises at least two rolls positioned as closely as possible to one of the stowing rollers, the rolls being in contact with the tape-spring wound in said stowing roller, and the rolls are capable of maintaining the tape-spring in the wound configuration, on the one hand, of the rolls and in the deployed configuration, on the other hand, of the rolls.

Advantageously, the deployable device according to the invention comprises an electric line positioned on a surface of at least one tape-spring and/or on an additional roller co-wound in a stowing roller and/or on an ancillary roller.

Advantageously, the tape-springs at least partially superposed in pairs over the contact surface form a hollow tube, and the deployable device further comprises a cable, preferably an electrical or mechanical cable, positioned in the hollow tube.

The invention also relates to a satellite comprising at least one deployable device as described above.

### BRIEF DESCRIPTION OF THE DRAWINGS

The invention will be better understood and further advantages will become apparent upon reading the detailed description of an embodiment given by way of example, the description being illustrated by the attached drawing, in which:

FIG. 1 shows a deployable device of bi-STEM type according to the prior art,

FIGS. 2A, 2B, 2C each show a deployable device according to the invention,

FIG. 3 shows a deployable device according to the invention in a sectional view of the deployable device, in terms of the two tape-springs thereof,

FIGS. 4A, 4B, 4C each show a sectional view of a “cylindrical” embodiment of a deployable device according to the invention, in terms of the tape-springs thereof,

FIGS. 5A, 5B, 5C each show a sectional view of an “omega” embodiment of a deployable device according to the invention, in terms of the tape-springs thereof,

FIGS. 6A, 6B, 6C each show a sectional view of a “U” or “ovoid” embodiment of a deployable device according to the invention, in terms of the tape-springs thereof,

FIG. 7 shows an embodiment of a deployable device according to the invention in the wound configuration and in the deployed configuration,

FIG. 8 shows an embodiment of a deployable device according to the invention in the wound configuration and holding an object in the stowed configuration,

FIG. 9 shows another embodiment of a deployable device with a cable according to the invention,

FIG. 10 schematically shows a satellite comprising at least one deployable device according to the invention.

For reasons of clarity, the same elements will bear the same references in the various figures.

### DETAILED DESCRIPTION

The invention applies to monostable or bistable tape-springs. The employment of monostable tape-springs requires greater guiding effort. Bistable tape-springs are preferred in terms of the uniform nature of their deployment. Furthermore, in the wound configuration, they remain wound, and in the deployed configuration they remain deployed.

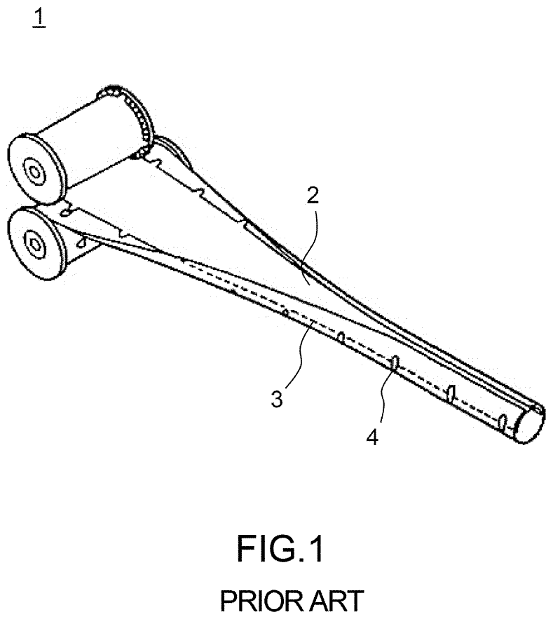

FIG. 1 shows a deployable device 1 of bi-STEM type according to the prior art and already described in the introduction.

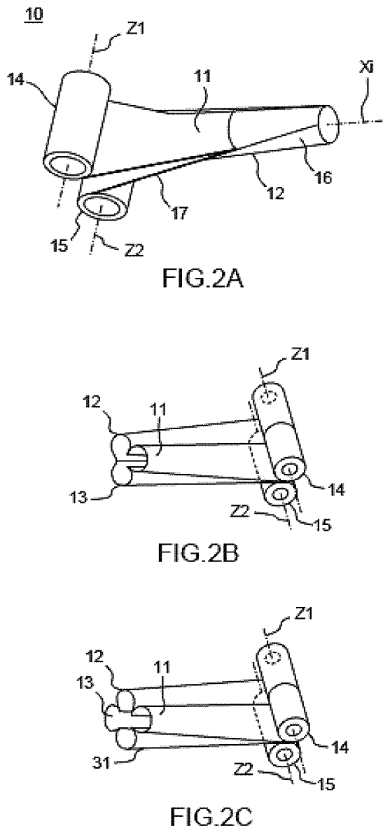

FIGS. 2A, 2B and 2C each show a deployable device 10 according to the invention. In FIG. 2A, the deployable device 10 comprises a plurality of stowing rollers that can each move in rotation about an axis Zi. Here, two stowing rollers 14, 15 are considered, and they can move in rotation respectively about axes Z1 and Z2 (which may be denoted more generally as Zi, i having a value ranging from 2 to a whole number equal to the number of stowing rollers and of tape-springs of the device 10). As explained below in the description, the device according to the invention may comprise three stowing rollers as shown in FIG. 2B, and they may, in this case, be movable in rotation respectively about axes Z1, Z2, Z3. In the case of four stowing rollers as shown in FIG. 2C, there may then be four axes of rotation Z1, Z2, Z3, Z4, etc.

In the case of a multiple number of tape-springs (11, 12, 13, 31), it is also possible to roll a plurality of said tape-springs on one and the same mandrel (14, 15) with the aim of saving space and/or mass. It is this configuration that is shown in FIGS. 2B and 2C, with two axes of rotation Z1 and Z2 for two mandrels 14, 15 in the case of three or four tape-springs.

The deployable device 10 comprises a plurality of tape-springs, in this case two tape-springs 11, 12, each being capable of passing from a wound configuration in one of the stowing rollers 14, 15 to a deployed configuration along an axis Xi substantially perpendicular to the axis Zi of the associated stowing roller 14, 15 (that is to say, Z1, Z2 respectively) and having a substantially concave face and a substantially convex face. The device according to the invention may comprise three or four tape-springs, or more, each tape-spring being wound in a respective stowing roller. In other words, the tape-springs are wound individually in a stowing roller, with opposed winding and wound outwards.

The concave faces of the tape-springs 11, 12 face one another. In other words, the concave faces of the tape-springs face one another in the deployed position or, when the tape-springs are not fully deployed, in the deployed portions of the tape-springs. The tape-springs 11, 12 are at least partially superposed in pairs over a contact surface 16. The contact surface 16 is defined by the one or more portion(s) where one part of a tape-spring straddles another part of another tape-spring.

According to the invention, the deployable device 10 comprises a reversible adherent link 17 on the contact surface 16 between at least two of the tape-springs 11, 12 in the deployed configuration, and the contact surface 16 is positioned between the concave face of a first 11, 12 of the tape-springs 11, 12 and the convex face of a second 12, 11 of the tape-springs 11, 12. Linked by means of the reversible adherent link 17, the tape-springs 11, 12 form a mast. Torsional stressing of the mast gives rise to a sliding movement between the tape-springs. The adherent material of the link 17 then works in shear over the entirety of the contact surface. This is also the case for flexural stressing of the mast, with a shear in the longitudinal direction of the mast. In other words, the positioning of the reversible adherent link between the concave face of one tape-spring and the convex face of the other tape-spring offers the advantage of better load take-up, with improved stiffness as compared with the known prior-art links: the more the surface is stressed, the better the loads will be taken up and the better the stiffness.

The reversible adherent link 17 offers the advantage of being reversible, that is to say that the tape-springs 11, 12 may be deployed and co-assembled and then wound and once again co-assembled for as many cycles as required. This is a removable link. The link 17 is a link based on adherence and there is thus no clearance between the two tape-springs once deployed and co-assembled. Lastly, this link is simple and reliable since it requires few components. Furthermore, reliable co-assembling of the tape-springs makes it possible to enhance the stiffness of the device during deployment and in the deployed configuration.

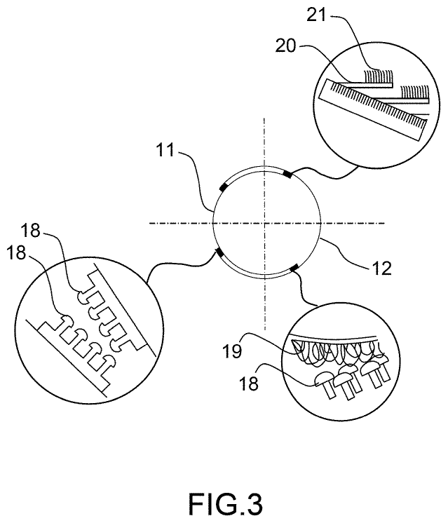

FIG. 3 shows a deployable device according to the invention in a sectional view of the deployable device, in terms of the two tape-springs 11, 12 thereof, perpendicularly to the axis Xi. The reversible adherent link 17 may comprise protuberances 18 on one tape-spring 12 and thread loops 19 on another tape-spring 11. This is the principle of mechanical fastening by means of hooks and loops (it should be noted that these loops may be textile or non-textile, for example metallic or metallized loops). When the tape-springs 11, 12 are placed in contact at the contact surface 16, the protuberances 18 catch in the loops 19 such as to achieve a removable adherent link 17 that may be split apart and re-made as many times as required.

The reversible adherent link 17 may also comprise protuberances 18 on one tape-spring 12 and protuberances 18 on another tape-spring 11. These protuberances extend along a trunk substantially perpendicularly to the surface of the tape-spring upon which they are located. At the free end of the trunk there is a cap, giving the protuberance the form of a mushroom. When the protuberances 18 of the two tape-springs are placed in contact, each cap of the protuberances of one tape-spring is inserted between two caps of the protuberances of the other tape-spring, thereby creating the reversible link 17.

These protuberances may be of microscopic size or even nanoscale in size.

FIG. 3 also shows another type of reversible adherent link 17. The reversible adherent link 17 may comprise a plurality of hairs 20 that adhere by means of Van der Waals forces, preferably setae 20, and more preferably setae 20 comprising spatular tips 21 at their end.

The setae 20 offer a very high level of adherence. They have the form of hairs that can branch out into the form of spatular tips 21. The size of the setae and that of the spatular tips are miniscule. One seta may, for example, measure 100 microns in length and a few microns in width. Each seta may contain several hundreds or even thousands of spatular tips measuring some nanometres in length and width. Depending on the density of the setae and spatular tips, the link 17 may comprise thousands of setae per mm² and millions of spatular tips to cause two faces of two tape-springs to adhere to one another.

The hairs may have a carbon, polymer or acrylic composition, or be in the form of silicon filaments. The reversible adherent link may also be constituted by an acrylic transfer adhesive bonded to a textured silicone strip or, alternatively, be in the form of the texturizing of a polyimide film or texturing with carbon nanotubes.

The reversible adherent link 17 on the contact surface 16 may be punctiform or linear. It may be located at the edges of one or more tape-springs, that is to say along the face of one or more tape-springs, continuously or linearly in the form of pieces or in a punctiform manner. It may also be located on the concave face of one tape-spring and/or on the convex face of the other tape-spring such that the concave face of one adheres to the convex face of the other. With this type of link, there is intermolecular coherence between the hairs on one tape-spring and the surface of the other tape-spring. This link offers the advantage of requiring the positioning of the hairs on a single face in order to cause two faces to adhere together.

It may be noted that the device according to the invention may comprise solely a single type of link (either protuberances/loops, or protuberances/protuberances, or hairs/smooth materials) or, alternatively, a combination of these types of link, for example protuberances/loops at the free end of the tape-springs and hairs beyond a certain deployment of the tape-springs.

The invention also offers the advantage of guaranteeing very good stiffness for the tape-springs. Indeed, once the device has been deployed, the tape-springs 11, 12 at least partially superposed in pairs over the contact surface 16 form a hollow tube 52. This tube 52 is flexurally stressed. However, by virtue of the adherent link 17, the device 10 preserves its tape-spring properties over the entire cross section. There is no need to reinforce the tape-springs locally. The thickness of the tape-springs may thus remain thin, which also makes it possible to maintain a certain level of winding compactness at the stowing rollers.

Furthermore, at least one tape-spring 11, 12 may have a non-constant thickness along an axis Yi substantially perpendicular to the axis Xi and to the axis Zi, preferably of decreasing thickness towards the free end 22, and/or a non-constant width along the axis Zi, preferably of decreasing width towards the free end 22. The evolution of the cross section of the tape-spring over the width thereof or in the thickness thereof makes it possible to adapt the stiffness of the assembly but also to achieve a saving in terms of overall mass.

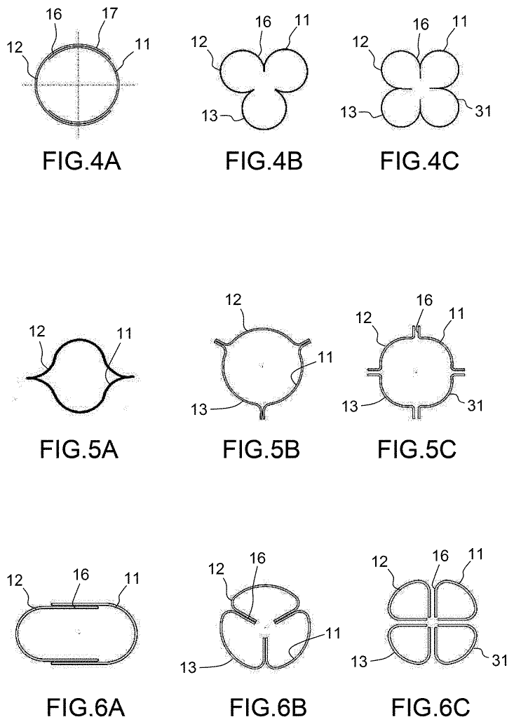

FIGS. 4A, 4B, 4C each show a sectional view of a “cylindrical” embodiment of a deployable device according to the invention, in terms of the tape-springs thereof, perpendicularly to the axis Xi. FIG. 4A is similar to FIG. 3 presented above. In the embodiment of FIG. 4A, the reversible adherent link 17 is located over the entire contact surface 16 between the two tape-springs 11, 12.

FIG. 4B shows an embodiment of the invention in which the deployable device comprises three tape-springs 11, 12, 13. There are three contact surfaces 16: between the tape-springs 11, 12 and 12, 13 and 13, 11.

FIG. 4C shows an embodiment of the invention in which the deployable device comprises four tape-springs 11, 12, 13, 31. There are four contact surfaces 16: between the tape-springs 11, 12 and 12, 13 and 13, 31 and 31, 11.

On the same principle, a deployable device according to the invention may comprise more than four tape-springs.

FIGS. 5A, 5B, 5C each show a sectional view of an “omega” embodiment of a deployable device according to the invention, in terms of the tape-springs thereof, perpendicularly to the axis Xi. In the embodiments shown, the contact surfaces are on the concave faces of the tape-springs, at the borders thereof. As explained above, the reversible adherent link 17 may be positioned over the entirety of the contact surfaces or, alternatively, over a part only, on the surface or in a punctiform manner.

FIGS. 6A, 6B, 6C each show a sectional view of a “U” or “ovoid” embodiment of a deployable device according to the invention, in terms of the tape-springs thereof, perpendicularly to the axis Xi. In the embodiments shown, the contact surfaces are on the convex faces of the tape-springs, on the exterior side, that is to say on the side opposite that where the concave faces are facing. As explained above, the reversible adherent link 17 may be positioned over the entirety of the contact surfaces or, alternatively, over a part only, on the surface or in a punctiform manner.

The choice of the number of tape-springs in the deployable device according to the invention depends on its application. A tube of greater cross section will offer greater stiffness in the deployed configuration. In this case, it may be advisable to use more than two tape-springs. In the case of torsional or flexural stressing, the cylindrical configuration of the tape-springs is the most advantageous.

The choice of the number of tape-springs also depends on the constraint of overall size in terms of the attachment point.

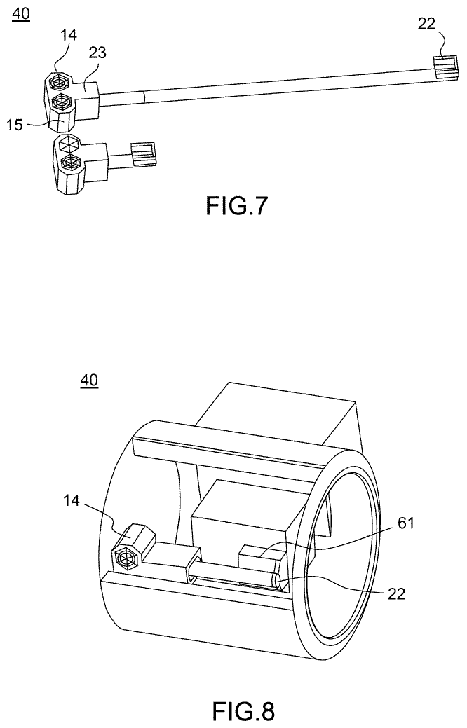

FIG. 7 shows an embodiment of a deployable device according to the invention in the wound configuration and in the deployed configuration. Each of the tape-springs 11, 12 has a free end 22. The free ends 22 of the tape-springs 11, 12 are linked rigidly together in the deployed configuration.

The deployable device 40 comprises a rotation drive motor 23 configured such as to drive the stowing rollers 14, 15. The fact that the stowing rollers are in co-driven contact makes it possible to have just a single motor for the deployment of two (or more) tape-springs.

FIG. 8 shows an embodiment of a deployable device 40 according to the invention in the wound configuration and holding an object 61 in the stowed configuration. The object may thus be held, notably at the time of the launch phase of a satellite. Subsequently, this object may be released (by a mechanism that is not shown), and the deployable device 40 may then pass from the wound configuration to the deployed configuration such as to distance the object 61 from the carrying structure.

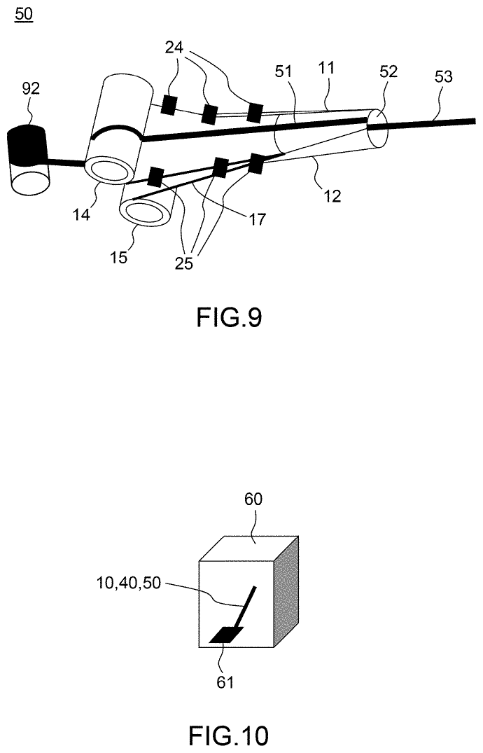

FIG. 9 shows another embodiment of a deployable device 50 with a cable according to the invention.

The deployable device 50 may thus comprise at least two rolls 24, 25 positioned as closely as possible to one of the stowing rollers, the rolls 24, 25 being in contact with the tape-spring 11 wound in said stowing roller 14. The rolls 24, 25 are capable of maintaining the tape-spring 11 in the wound configuration on the one hand of the rolls and in the deployed configuration on the other hand of the rolls 24, 25. In FIG. 9, six rolls are shown (three on either side of the tape-springs). It is perfectly easy to envisage positioning more rolls, for example about ten rolls.

It is also possible to make provision for a fixed central roll in order to prestress idle stowing rollers.

In the embodiment shown in FIG. 9, the deployable device 50 comprises an electric line 51 positioned on a surface of a tape-spring 11. The electric line on the tape-spring 11 makes it possible to provide power at the end of the deployable device. In this case, it is possible to provide an electrical collector in the tape-spring guide. The electric line 51 may also be on an additional roller co-wound in a stowing roller and/or on an ancillary roller with cable strands.

According to another embodiment of the deployable device 50, the tape-springs 11, 12 at least partially superposed in pairs over the contact surface 16 form a hollow tube 52. The deployable device 50 may further comprise a cable 53, preferably an electrical or mechanical cable, positioned in the hollow tube 52. In addition to being able to distance an object 61 from the carrying structure, the deployable device 50 also makes it possible to make an electrical or mechanical cable (for example in order to tow a satellite) available at the end of the device 50, even in the deployed configuration.

FIG. 10 schematically shows a satellite 60 comprising at least one deployable device according to the invention and allowing the distancing of an object 61 from the carrying structure of the satellite 60.

1. A deployable device comprising:
a plurality of stowing rollers that can each move in rotation about a first axis Zi, a plurality of tape-springs, each being capable of passing from a wound configuration in one of the stowing rollers to a deployed configuration along a second axis Xi substantially perpendicular to the first axis Zi of the associated stowing roller and having a substantially concave face and a substantially convex face, the concave faces of the tape-springs facing one another, the tape-springs being at least partially superposed in pairs over a contact surface,
a reversible adherent link on the contact surface between at least two of the tape-springs in the deployed configuration,
wherein the contact surface is positioned between the concave face of a first of the tape-springs and the convex face of a second of the tape-springs.

2. The deployable device according to claim 1, wherein the reversible adherent link comprises protuberances on one tape-spring and thread loops on another tape-spring.

3. The deployable device according to claim 1, wherein the reversible adherent link comprises a plurality of hairs that adhere by means of Van der Waals forces, preferably setae, and more preferably setae comprising spatular tips at their end.

4. The deployable device according to claim 1, wherein the reversible adherent link on the contact surface is punctiform or linear.

5. The deployable device according to claim 1, each of the plurality of tape-springs having a free end, wherein the free ends of the plurality of tape-springs are linked rigidly together in the deployed configuration.

6. The deployable device according to claim 1, each of the plurality of tape-springs having a free end, wherein at least one tape-spring of the plurality of tape-springs has a non-constant thickness along a third axis Yi substantially perpendicular to the second axis Xi and to the first axis Zi, preferably of decreasing thickness towards the free end, and/or a non-constant width along the first axis Zi, preferably of decreasing width towards the free end.

7. The deployable device according to claim 1, wherein it comprises a rotation drive motor configured such as to drive the plurality of stowing rollers.

8. The deployable device according to claim 1, wherein it comprises at least two rolls positioned as closely as possible to one of the stowing rollers, the rolls being in contact with the tape-spring wound in said stowing roller, and in that the rolls are capable of maintaining the tape-spring in the wound configuration, on the one hand, of the rolls and in the deployed configuration, on the other hand, of the rolls.

9. The deployable device according to claim 1, wherein it comprises an electric line positioned on a surface of at least one tape-spring and/or on an additional roller co-wound in a stowing roller and/or on an ancillary roller.

10. The deployable device according to claim 1, wherein the tape-springs at least partially superposed in pairs over the contact surface form a hollow tube, and in that the deployable device further comprises a cable, preferably an electrical or mechanical cable, positioned in the hollow tube.

11. A satellite wherein it comprises at least one deployable device according to claim 1.
